(19) United States
(12) Patent Application Publication
(10) Pub. No.: US 2024/0029113 A1
(43) Pub. Date: Jan. 25, 2024

(54) INFORMATION PROCESSING SYSTEM

(71) Applicant: DENTSU INC., Tokyo (JP)

(72) Inventor: Ryo SUETOMI, Tokyo (JP)

(73) Assignee: DENTSU INC., Tokyo (JP)

(21) Appl. No.: 18/254,220

(22) PCT Filed: Oct. 1, 2021
(86) PCT No.: PCT/JP2021/036408

§ 371 Date: May 24, 2023

(30) Foreign Application Priority Data
Nov. 30, 2020 (JP) 2020-197819

(51) Int. Cl. G06Q 30/0251; G06F 3/01; G06Q 30/0241

(52) U.S. Cl. CPC G06Q 30/0269; G06F 3/011; G06Q 30/0277

(57) ABSTRACT

An information processing system includes: a motion data acquisition unit that acquires motion data, in a real environment, of a user who is operating an avatar in a virtual reality space; and an attribute estimation unit that estimates an attribute of the user on a basis of the acquired motion data.

### TECHNICAL FIELD

The present disclosure is related to an information processing system that estimates an attribute of a user operating an avatar in a virtual reality space.

### BACKGROUND ART

Conventionally, a technique is known by which an advertisement is displayed for a user in a virtual reality space; however, it has not been possible to place advertisements varied in accordance with attributes of users, because it is not possible to estimate users of a head-mounted display (HMD) without having information input in advance.

Japanese Patent Laid-Open No. 2018-190164 proposes a technique by which a series of past actions (e.g., actions of picking up an item in the virtual reality space, giving the picked-up item to a person appearing in a virtual reality space, and receiving another item in exchange) of a user in the virtual reality space are stored (registered) in advance as an authentication password, and it is determined whether or not a new action taken by the user in the virtual reality space has a correlation equal to or larger than a prescribed level with the past actions stored (registered) in advance, so as to authenticate the user on the basis of a determined result.

### SUMMARY OF INVENTION

However, the technique described in Japanese Patent Laid-Open No. 2018-190164 is a technique for authenticating the user (confirming that his/her identity is not spoofed by someone else besides the user). Thus, it is not possible to estimate an attribute (the gender, the age, and/or the like) of the user. Further, according to the technique described in Japanese Patent Laid-Open No. 2018-190164, in order to authenticate the user, it is necessary to store (register) in advance (before the authentication), the series of past actions of the user in the virtual reality space as the authentication password, which means that the user is required to input the information in advance.

As a technique for estimating an attribute of a user using a web browser without having information input in advance, a method is known by which a cookie saved in the web browser is acquired and used. However, from a standpoint of privacy protection, acquiring cookies is expected to become difficult in the future. Thus, there is a demand for a technique that makes it possible to estimate attributes of users without using cookies.

There is a demand for providing a technique that makes it possible to estimate an attribute of a user operating an avatar in a virtual reality space, without having information input in advance.

An information processing system according to one aspect of the present disclosure includes:
a motion data acquisition unit that acquires motion data, in a real environment, of a user who is operating an avatar in a virtual reality space; and
an attribute estimation unit that estimates an attribute of the user on a basis of the acquired motion data.

An information processing system according to another aspect of the present disclosure includes:
an action log acquisition unit that acquires an action log, in a virtual reality space, of an avatar operated by a user; and
an attribute estimation unit that estimates an attribute of the user, on a basis of the acquired action log.

### BRIEF DESCRIPTION OF DRAWINGS

FIG. 1 is a diagram showing a schematic configuration of an information processing system according to a first embodiment.

FIG. 2 is a diagram showing a schematic configuration of an information processing system according to a modification example of the first embodiment.

FIG. 3A is a drawing for explaining an example of a process of estimating an attribute of a user on the basis of motion data of the user.

FIG. 3B is a drawing for explaining an example of a process of estimating an attribute of another user on the basis of motion data of the user.

FIG. 4 is a flowchart showing an example of an operation of the information processing system according to the first embodiment.

FIG. 5 is a diagram showing a schematic configuration of an information processing system according to a second embodiment.

FIG. 6 is a flowchart showing an example of an operation of an information processing system according to the second embodiment.

### DESCRIPTION OF EMBODIMENTS

An information processing system according to a first aspect of embodiments includes:
a motion data acquisition unit that acquires motion data, in a real environment, of a user who is operating an avatar in a virtual reality space; and
an attribute estimation unit that estimates an attribute of the user on a basis of the acquired motion data.

According to the aspect described above, by acquiring the motion data, in the real environment, of the user who is operating the avatar in the virtual reality space and estimating the attribute of the user on the basis of the motion data, it is possible to estimate the attribute of the user, without having information input by the user in advance and without the need to use cookies.

An information processing system according to a second aspect of the embodiments is the information processing system according to the first aspect, further including:
an advertisement output unit that outputs an advertisement corresponding to the estimated attribute to an inside of the virtual reality space.

According to the aspect described above, it is possible to place advertisements varied in accordance with attributes of users and to thus enhance effects of the advertisements.

An information processing system according to a third aspect of the embodiments is the information processing system according to the first or the second aspect, wherein
the attribute estimation unit includes:
   a first estimation unit that estimates a movement of a skeletal structure of the user, on the basis of the acquired motion data; and
   a second estimation unit that estimates the attribute of the user on a basis of the estimated movement of the skeletal structure.

An information processing system according to a fourth aspect of the embodiments is the information processing system according to any one of the first to the third aspects, wherein
the motion data acquisition unit acquires the motion data from at least one selected from among: a head-mounted display and/or a controller used by the user for operating the avatar; a camera that images the user; and a tracking sensor attached to a trunk and/or a limb of the user.

An information processing system according to a fifth aspect of the embodiments is the information processing system according to any one of the first to the fourth aspects, wherein
the attribute of the user includes at least one of an age and a gender of the user.

An information processing method according to a sixth aspect of the embodiments is an information processing method implemented by a computer, the information processing method including:
a step of acquiring motion data, in a real environment, of a user who is operating an avatar in a virtual reality space; and
a step of estimating an attribute of the user on a basis of the acquired motion data.

An information processing program according to a seventh aspect of the embodiments is an information processing program for causing a computer to execute:
a step of acquiring motion data, in a real environment, of a user who is operating an avatar in a virtual reality space; and
a step of estimating an attribute of the user on a basis of the acquired motion data.

An information processing system according to an eighth aspect of the embodiments includes:
an action log acquisition unit that acquires an action log, in a virtual reality space, of an avatar operated by a user; and
an attribute estimation unit that estimates an attribute of the user, on a basis of the acquired action log.

According to the aspects described above, by acquiring the action log, in the virtual reality space, of the avatar operated by the user and estimating the attribute of the user on the basis of the action log, it is possible to estimate the attribute of the user, without having information input by the user in advance and without the need to use cookies.

An information processing system according to a ninth aspect of the embodiments is the information processing system according to the eighth aspect, further including:
an advertisement output unit that outputs an advertisement corresponding to the estimated attribute to an inside of the virtual reality space.

According to the aspect described above, it is possible to place advertisements varied in accordance with attributes of users and to thus enhance effects of the advertisements.

An information processing system according to a tenth aspect of the embodiments is the information processing system according to the eighth or the ninth aspect, wherein
the action log includes at least one selected from among: a world visited by the avatar; an object grasped by the avatar; who had a conversation with the avatar; and what the avatar saw.

An information processing system according to an eleventh aspect of the embodiments is the information processing system according to any one of the eighth to the tenth aspects, wherein
the attribute of the user includes at least one of an age and a gender of the user.

An information processing method according to a twelfth aspect of the embodiments is an information processing method implemented by a computer, the information processing method including:
a step of acquiring an action log, in a virtual reality space, of an avatar operated by a user; and
a step of estimating an attribute of the user, on a basis of the acquired action log.

An information processing program according to a thirteenth aspect of the embodiments is an information processing program for causing a computer to execute:
a step of acquiring an action log, in a virtual reality space, of an avatar operated by a user; and
a step of estimating an attribute of the user, on a basis of the acquired action log.

The following will describe specific examples of the embodiments in detail, with reference to the accompanying drawings. In the following description and in the drawings to be referenced thereby, some of the elements that can be the same as each other will be referred to by using the same reference characters, and duplicate explanations thereof will be omitted.

### First Embodiment

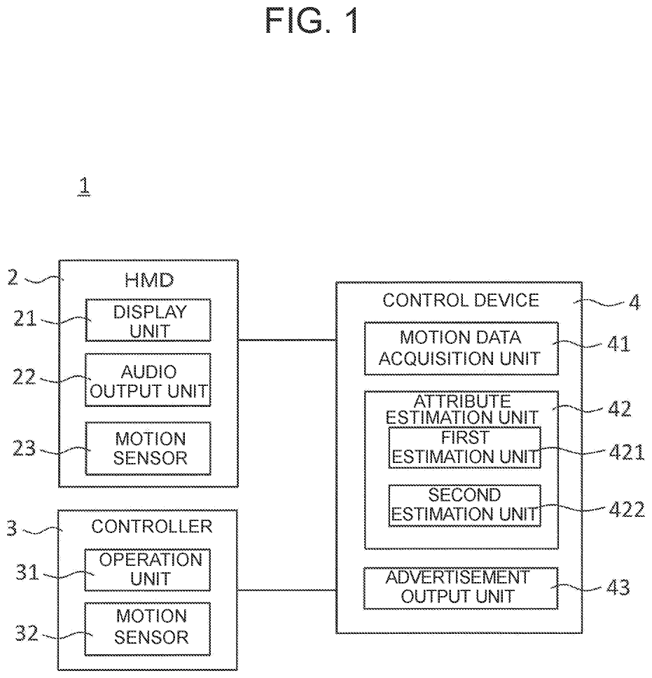

FIG. 1 is a diagram showing a schematic configuration of an information processing system 1 according to a first embodiment. The information processing system 1 is a system that estimates an attribute of a user operating an avatar in a virtual reality space.

As shown in FIG. 1, the information processing system 1 includes a head-mounted display (HMD) 2, a controller 3, and a control device 4. The head-mounted display 2 and the control device 4 are able to communicate with each other (preferably, via a wireless connection), and the control device 4 and the controller 3 are also able to communicate with each other.

Of these elements, the head-mounted display 2 is an interface that is worn on the head of the user and that outputs various types of information to the user. The head-mounted display 2 includes a display unit 21, an audio output unit 22, and a motion sensor 23.

The display unit 21 may be, for example, a liquid crystal display, an organic EL display, or the like and is configured to cover a field of view of both of the eyes of the user wearing the head-mounted display 2. As a result, the user is able to see a picture displayed on the display unit 21. The display unit 21 may display a still image, a video, a document, a homepage, or any of other arbitrary objects (electronic files). Display modes of the display unit 21 are not particularly limited. It is possible to use a mode in which an object is displayed in an arbitrary position within a virtual space (the virtual reality space) having a depth. It is also possible to use a mode in which an object is displayed in an arbitrary position on a virtual plane.

The audio output unit 22 is an interface that outputs various types of information to the user in the form of sounds (a sound wave or bone conduction) and may be, for example, an earphone, headphones, a speaker, or the like.

The motion sensor 23 is a means for detecting the orientation and movements (acceleration, rotation, and the like) of the head of the user in a real environment. The motion sensor 23 may include various types of sensors such as, for example, an acceleration sensor, an angular velocity sensor (a gyro sensor), or a geomagnetic sensor.

The controller 3 is an input interface that is held in the hands of the user and that receives operations from the user. The controller 3 includes an operation unit 31 and a motion sensor 32.

The operation unit 31 is a means for receiving inputs corresponding to movements of one or more fingers of the user and may be, for example, a button, a lever, a cross key, a touchpad, or the like. By using operation inputs through the operation unit 31, the user is able to cause the avatar to move or speak in the virtual reality space.

The motion sensor 32 is a means for detecting the orientations and movements (acceleration, rotation, and the like) of the hands (or the arms) of the user in the real environment. The motion sensor 32 may include various types of sensors such as, for example, an acceleration sensor, an angular velocity sensor (a gyro sensor), or a geomagnetic sensor.

Next, the control device 4 will be explained. In the shown example, the control device 4 is configured by using a single computer; however, possible embodiments are not limited to this example. The control device 4 may be configured by using a plurality of computers connected so as to be able to communicate with one another via a network. A part or all of functions of the control device 4 may be realized as a result of a processor executing a prescribed information processing program or may be realized by using hardware.

As shown in FIG. 1, the control device 4 includes a motion data acquisition unit 41, an attribute estimation unit 42, and an advertisement output unit 43.

Of these elements, the motion data acquisition unit 41 acquires motion data, in the real environment, of the user who is operating the avatar in the virtual reality space. More specifically, for example, the motion data acquisition unit 41 may acquire, as the motion data, data obtained by detecting the orientation and movements (acceleration, rotation, and the like) of the head of the user in the real environment, from the head-mounted display 2. As another example, the motion data acquisition unit 41 may acquire, as the motion data, data obtained by detecting the orientations and movements (acceleration, rotation, and the like) of the hands (or the arms) of the user in the real environment, from the controller 3.

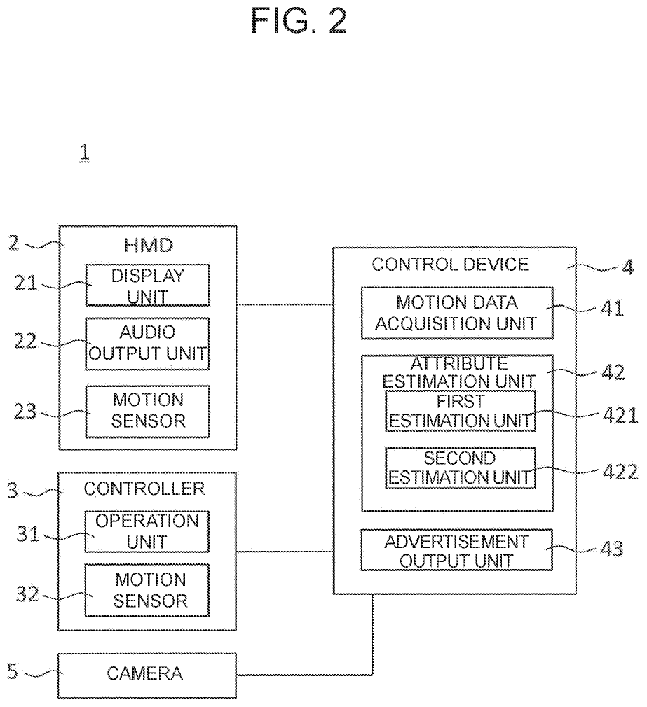

In a modification example, as shown in FIG. 2, when a camera 5 that images the user from the outside is communicably connected to the control device 4, the motion data acquisition unit 41 may acquire, as the motion data, image data obtained by imaging the orientation and movements (acceleration, rotation, and the like) of the body of the user in the real environment, from the camera 5.

Although not shown in the drawings, when one or more additional tracking sensors (not shown) are attached to the trunk (e.g., the waist) and/or a limb (e.g., a leg) of the user, the motion data acquisition unit 41 may acquire, as the motion data, data obtained by detecting the orientations and movements (acceleration, rotation, and the like) of the trunk and/or the limb of the user in the real environment, from the one or more tracking sensors.

The attribute estimation unit 42 estimates an attribute (e.g., the age, the gender, the height, and/or the like) of the user, on the basis of the motion data in the real environment that was acquired by the motion data acquisition unit 41. In the shown example, the attribute estimation unit 42 includes a first estimation unit 421 and a second estimation unit 422.

On the basis of the motion data in the real environment that was acquired by the motion data acquisition unit 41, the first estimation unit 421 estimates movements of the skeletal structure (e.g., a speed of squatting, how the shoulders are raised and a range of motion thereof, the lengths of the arms and the legs, and/or the like) of the user. More specifically, for example, the first estimation unit 421 may estimate the movements of the skeletal structure of the user while using a trained model that machine-learned a relationship between past motion data, in real environments, of a plurality of users and movements of the skeletal structures of these users and inputting thereto the new motion data acquired by the motion data acquisition unit 41. As a machine learning algorithm, deep learning may be used, for example. Alternatively, for instance, the first estimation unit 421 may estimate the movements of the skeletal structure of the user while using a rule (a correspondence table or a function) that defines a relationship between measured values of motion data of the user in the real environment and the movements of the skeletal structure of the user and using the motion data newly acquired by the motion data acquisition unit 41 as an input. As the motion data, when the motion data acquisition unit 41 has acquired, from the camera 5, image data obtained by imaging the orientation and the movements (acceleration, rotation, and the like) of the body of the user in the real environment, the first estimation unit 421 may estimate the movements of the skeletal structure of the user by performing image processing on the image data.

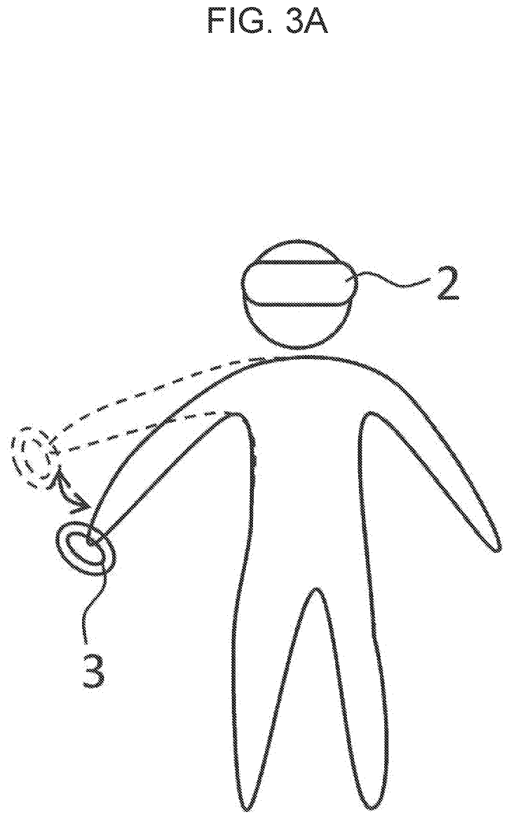

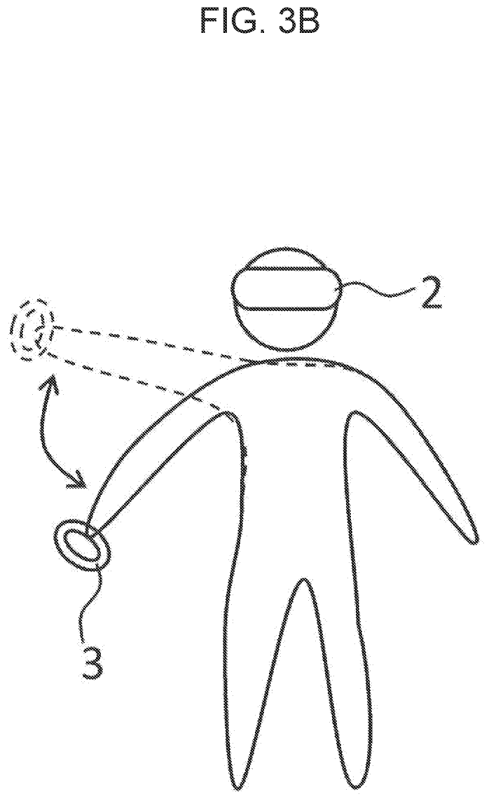

On the basis of the movements of the skeletal structure (e.g., a speed of squatting, how the shoulders are raised and a range of motion thereof, the lengths of the arms and the legs, and/or the like) estimated by the first estimation unit 421, the second estimation unit 422 estimates the attribute of the user (e.g., the age, the gender, the height, and/or the like). In an example, as shown in FIG. 3A, when how the user's shoulders are raised is lower than a prescribed value (or when the range of motion of the shoulders is smaller than a prescribed value), the age of the user may be estimated as 40 or older. As another example, when how the user's shoulders are raised is lower than the prescribed value (or when the range of motion of the shoulders is smaller than the prescribed value), while, in addition, the squatting speed of the user is also lower than a prescribed value, the age of the user may be estimated as 50 or older. On the contrary, as shown in FIG. 3B, when how the user's shoulders are raised is higher than the prescribed value (or when the range of motion of the shoulders is larger than the prescribed value), the age of the user may be estimated as 39 or younger. As another example, when how the user's shoulders are raised is higher than the prescribed value (or when the range of motion of the shoulders is larger than the prescribed value), while, in addition, the squatting speed of the user is also higher than the prescribed value, the age of the user may be estimated as 29 or younger.

The second estimation unit 422 may estimate the attribute of the user by using a rule-based method (using a correspondence table or a function), while using the movements of the skeletal structure estimated by the first estimation unit 421 as an input or may estimate the attribute of the user by using a trained model that machine-learned a relationship between the movements of the skeletal structure and the attribute of the user. As a machine learning algorithm, deep learning may be used, for example.

The advertisement output unit 43 acquires an advertisement (e.g., an audio advertisement, a video advertisement, or a 3D object advertisement) corresponding to the attribute estimated by the attribute estimation unit 42, from an external advertiser server (not shown), for example, and further outputs the acquired advertisement to the inside of the virtual reality space via the display unit 21 or the audio output unit 22 of the head-mounted display 2.

When the advertisement is an advertisement for a real product in the real environment, the advertisement output unit 43 may output the advertisement corresponding to the attribute of the user himself/herself to the inside of the virtual reality space. In another example, when the advertisement is an advertisement for a virtual product in the virtual reality space, the advertisement output unit 43 may output the advertisement taking avatar information into consideration to the inside of the virtual reality space. For example, the advertisement output unit 43 may output an advertisement for an option item of wings for an animal avatar and may output an advertisement for an option item for nails for a female avatar.

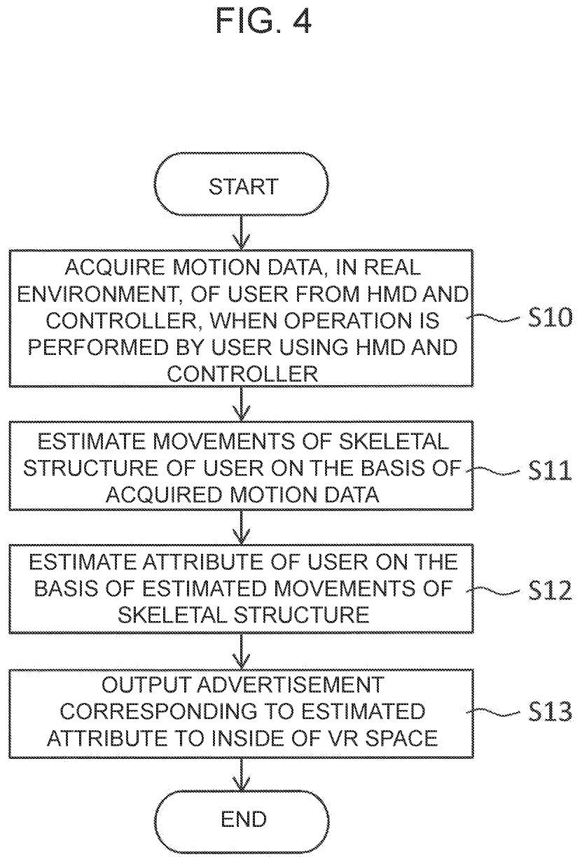

Next, an example of an operation of the information processing system 1 configured as described above will be explained, with reference to FIG. 4. FIG. 4 is a flowchart showing the example of the operation of the information processing system 1.

As shown in FIG. 4, to begin with, when the user operates an avatar in the virtual reality space by using the head-mounted display 2 and the controller 3, the motion data acquisition unit 41 acquires, from the head-mounted display 2 and the controller 3, motion data, in the real environment, of the user who is operating the avatar (step S10). The motion data acquisition unit 41 may acquire the motion data, in the real environment, of the user who is operating the avatar, from the camera 5 or a tracking sensor (not shown).

Subsequently, the attribute estimation unit 42 estimates an attribute (e.g., the age, the gender, the height, and/or the like) of the user, on the basis of the motion data in the real environment that was acquired by the motion data acquisition unit 41.

More specifically, for example, the first estimation unit 421 at first estimates movements of the skeletal structure (e.g., a speed of squatting, how the shoulders are raised and a range of motion thereof, the lengths of the arms and the legs, and/or the like) of the user, on the basis of the motion data in the real environment that was acquired by the motion data acquisition unit 41 (step S11).

Subsequently, on the basis of the movements of the skeletal structure (e.g., a speed of squatting, how the shoulders are raised and a range of motion thereof, the lengths of the arms and the legs, and/or the like) estimated by the first estimation unit 421, the second estimation unit 422 estimates the attribute (e.g., the age, the gender, the height, and/or the like) of the user (step S12).

After that, the advertisement output unit 43 acquires an advertisement (e.g., an audio advertisement, a video advertisement, or a 3D object advertisement) corresponding to the attribute estimated by the attribute estimation unit 42 from an external advertiser server (not shown), for example, and further outputs the acquired advertisement to the inside of the virtual reality space via the display unit 21 or the audio output unit 22 of the head-mounted display 2.

According to the present embodiment described above, the motion data acquisition unit 41 acquires the motion data, in the real environment, of the user who is operating the avatar in the virtual reality space, and the attribute estimation unit 42 estimates the attribute of the user on the basis of the motion data. Accordingly, it is possible to estimate the attribute of the user, without having information input by the user in advance and without the need to use cookies saved in a web browser.

Further, according to the present embodiment, the advertisement output unit 43 outputs the advertisement corresponding to the attribute estimated by the attribute estimation unit 42 to the inside of the virtual reality space. It is therefore possible to place targeted advertisements varied in accordance with attributes of users and to thus enhance effects of the advertisements.

### Second Embodiment

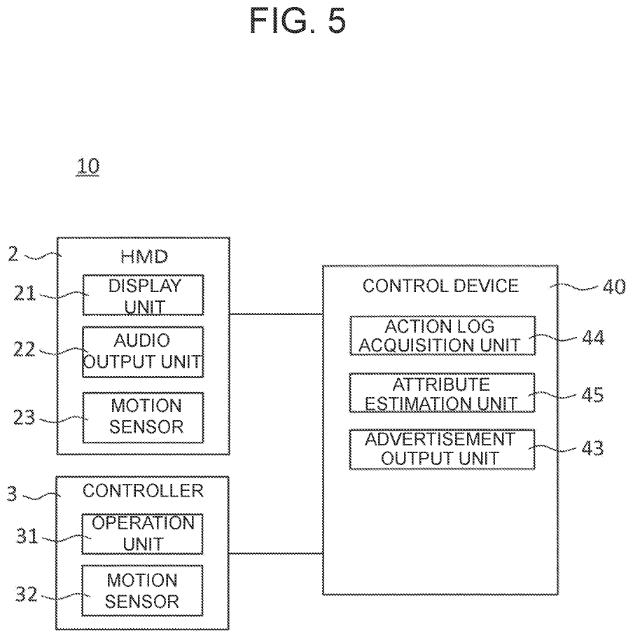

Next, an information processing system 10 according to a second embodiment will be explained. FIG. 5 is a diagram showing a schematic configuration of the information processing system 10 according to the second embodiment.

As shown in FIG. 2, the information processing system 10 includes the head-mounted display (HMD) 2, the controller 3, and a control device 40. The head-mounted display 2 and the control device 40 are able to communicate with each other (preferably, via a wireless connection), and the control device 40 and the controller 3 are also able to communicate with each other.

Of these elements, because the configurations of the head-mounted display 2 and the controller 3 are the same as those described above in the first embodiment, explanations thereof will be omitted.

In the shown example, the control device 40 is configured by using a single computer; however, possible embodiments are not limited to this example. The control device 40 may be configured by using a plurality of computers connected so as to be able to communicate with one another via a network. A part or all of functions of the control device 40 may be realized as a result of a processor executing a prescribed information processing program or may be realized by using hardware.

As shown in FIG. 5, the control device 40 includes an action log acquisition unit 44, an attribute estimation unit 45, and the advertisement output unit 43.

Of these elements, the action log acquisition unit 44 is configured to acquire an action log, in the virtual reality space, of the avatar operated by the user. In this situation, the action log may include, for example, at least one selected from among: a world visited by the avatar in the virtual reality space (which world was visited); an object grasped by the avatar in the virtual reality space (what was grasped); who had a conversation with the avatar in the virtual reality space, and what avatar saw in the virtual reality space (what was seen).

On the basis of the action log of the avatar in the virtual reality space that was acquired by the action log acquisition unit 44, the attribute estimation unit 45 estimates an attribute (e.g., the age, the gender, the height, and/or the like) of the user operating the avatar. For example, on the basis of the action log of the avatar, the attribute estimation unit 45 may roughly categorize preferences of the user operating the avatar so as to estimate the attribute of the user on the basis of the roughly categorized preferences of the user.

The attribute estimation unit 45 may estimate the attribute of the user by using a rule-based method (using a correspondence table or a function), while using the action log of the avatar in the virtual reality space that was acquired by the action log acquisition unit 44 as an input or may estimate the attribute of the user by using a trained model that machine-learned a relationship between past action logs of a plurality of avatars and attributes of one or more users operating the avatars. As a machine learning algorithm, deep learning may be used, for example.

When estimating the attribute of the user operating the avatar on the basis of the action log of the avatar in the virtual reality space that was acquired by the action log acquisition unit 44, the attribute estimation unit 45 may estimate the attribute of the user by further performing a matching process on vital data (e.g., a heartrate acquired from a wearable device of the user) of the user.

The advertisement output unit 43 acquires an advertisement (e.g., an audio advertisement, a video advertisement, or a 3D object advertisement) corresponding to the attribute estimated by the attribute estimation unit 42, from an external advertiser server (not shown), for example, and further outputs the acquired advertisement to the inside of the virtual reality space via the display unit 21 or the audio output unit 22 of the head-mounted display 2.

When the advertisement is an advertisement for a real product in the real environment, the advertisement output unit 43 may output the advertisement corresponding to the attribute of the user himself/herself to the inside of the virtual reality space. In another example, when the advertisement is an advertisement for a virtual product in the virtual reality space, the advertisement output unit 43 may output the advertisement taking avatar information into consideration to the inside of the virtual reality space. For example, the advertisement output unit 43 may output an advertisement for an option item of wings for an animal avatar and may output an advertisement for an option item for nails for a female avatar.

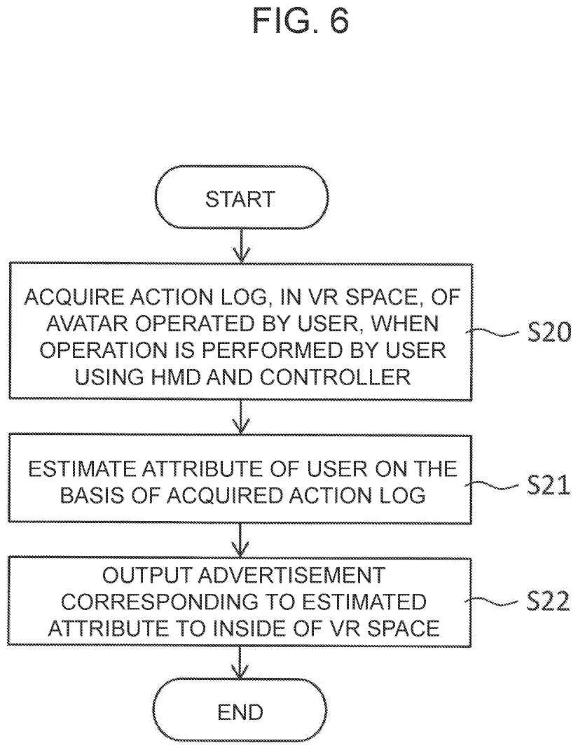

Next, an example of an operation of the information processing system 10 configured as described above will be explained, with reference to FIG. 6. FIG. 6 is a flowchart showing the example of the operation of the information processing system 10.

As shown in FIG. 6, to begin with, when the user operates an avatar in the virtual reality space by using the head-mounted display 2 and the controller 3, the action log acquisition unit 44 acquires an action log of the avatar in the virtual reality space (step S20).

Subsequently, on the basis of the action log of the avatar in the virtual reality space that was acquired by the action log acquisition unit 44, the attribute estimation unit 45 estimates an attribute (e.g., the age, the gender, the height, and/or the like) of the user operating the avatar (step S21).

After that, the advertisement output unit 43 acquires an advertisement (e.g., an audio advertisement, a video advertisement, or a 3D object advertisement) corresponding to the attribute estimated by the attribute estimation unit 42, from an external advertiser server (not shown), for example, and further outputs the acquired advertisement to the inside of the virtual reality space via the display unit 21 or the audio output unit 22 of the head-mounted display 2.

According to the present embodiment described above, the action log acquisition unit 44 acquires the action log, in the virtual reality space, of the avatar operated by the user, and the attribute estimation unit 45 estimates the attribute of the user on the basis of the action log. Accordingly, it is possible to estimate the attribute of the user, without having information input by the user in advance and without the need to use cookies saved in a web browser.

Further, according to the present embodiment, similarly to the first embodiment described above, the advertisement output unit 43 outputs the advertisement corresponding to the attribute estimated by the attribute estimation unit 42 to the inside of the virtual reality space. It is therefore possible to place advertisements varied in accordance with attributes of users and to thus enhance effects of the advertisements.

Further, the above description of the embodiments and the disclosure of the drawings are merely examples for explaining the invention set forth in the claims. Thus, the invention set forth in the claims is not limited by the above description of the embodiments and the disclosure of the drawings. It is possible to arbitrarily combine any of the constituent elements of the above embodiments without departing from the gist of the invention.

Further at least a part of the information processing system 1, 10 according to the present embodiments may be configured by using a computer. The matters for which protection is sought in the present application include a program that causes a computer to realize at least a part of the information processing system 1, 10 and a computer-readable recording medium that has the program recorded thereon in a non-transitory manner.

1. An information processing system comprising:
a motion data acquisition unit that acquires motion data, in a real environment, of a user who is operating an avatar in a virtual reality space; and
an attribute estimation unit that estimates an attribute of the user on a basis of the acquired motion data.

2. The information processing system according to claim 1, further comprising:
an advertisement output unit that outputs an advertisement corresponding to the estimated attribute to an inside of the virtual reality space.

3. The information processing system according to claim 1, wherein
the attribute estimation unit includes:
a first estimation unit that estimates a movement of a skeletal structure of the user, on the basis of the acquired motion data; and
a second estimation unit that estimates the attribute of the user on a basis of the estimated movement of the skeletal structure.

4. The information processing system according to claim 1, wherein
the motion data acquisition unit acquires the motion data from at least one selected from among: a head-mounted display and/or a controller used by the user for operating the avatar; a camera that images the user; and a tracking sensor attached to a trunk and/or a limb of the user.

5. The information processing system according to claim 1, wherein
the attribute of the user includes at least one of an age and a gender of the user.

6. An information processing method implemented by a computer, the information processing method comprising:
a step of acquiring motion data, in a real environment, of a user who is operating an avatar in a virtual reality space; and
a step of estimating an attribute of the user on a basis of the acquired motion data.

7. An information processing program for causing a computer to execute:
a step of acquiring motion data, in a real environment, of a user who is operating an avatar in a virtual reality space; and
a step of estimating an attribute of the user on a basis of the acquired motion data.

8. An information processing system comprising:
an action log acquisition unit that acquires an action log, in a virtual reality space, of an avatar operated by a user; and
an attribute estimation unit that estimates an attribute of the user, on a basis of the acquired action log.

9. The information processing system according to claim 8, further comprising:
an advertisement output unit that outputs an advertisement corresponding to the estimated attribute to an inside of the virtual reality space.

10. The information processing system according to claim 8, wherein
the action log includes at least one selected from among: a world visited by the avatar; an object grasped by the avatar; who had a conversation with the avatar; and what the avatar saw.

11. The information processing system according to claim 8, wherein
the attribute of the user includes at least one of an age and a gender of the user.

12. An information processing method implemented by a computer, the information processing method comprising:
a step of acquiring an action log, in a virtual reality space, of an avatar operated by a user; and
a step of estimating an attribute of the user, on a basis of the acquired action log.

13. An information processing program for causing a computer to execute:
a step of acquiring an action log, in a virtual reality space, of an avatar operated by a user; and
a step of estimating an attribute of the user, on a basis of the acquired action log.
